(19) United States
(12) Patent Application Publication
(10) Pub. No.: US 2007/0033634 A1
(43) Pub. Date: Feb. 8, 2007

(54) User-profile controls rendering of content information

(75) Inventors: Nathalie Dorothee Pieternel Leurs, Eindhoven (NL); Nicoline Haisma, Eindhoven (NL); Robertus Laurentius Clemens De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/569,174

(22) PCT Filed: Aug. 10, 2004
(86) PCT No.: PCT/IB04/51435

§ 371 Date: Feb. 22, 2006

(30) Foreign Application Priority Data
Aug. 29, 2003 (EP) 03103247.7

(51) Int. Cl. H04N 7/16

(52) U.S. Cl. 725/143

(57) ABSTRACT

A method is proposed of enabling to render mass-market content information to a user. The method comprises enabling to use a provile of the user for control of processing the electronic content for the purpose of personalizing the rendering during play-out of the content.

### FIELD OF THE INVENTION

The invention relates to a method of enabling to render content information, to a system and components thereof for enabling to render the content, to content information and to control software.

### BACKGROUND ART

Advanced communication technologies are driving a current trend in society that is giving rise to an increasing number of subcultures, physical and virtual, with members from all over the globe. A person can belong to many groups at the same time, e.g. be a music fan, hobbyist, sportsman or sportswoman, businessperson, classmate, user of a particular brand of product, etc. This sort of grouping has a highly temporal character as people move into or out of certain groups depending on their dominant identity at the moment.

Accordingly, people may assume multiple social or activity-related identities and it depends on their context which identity (or interest) is dominant. For example, a person may be receptive of information about food supplements while sporting, but ignores this information during the break of an exiting thriller.

### SUMMARY OF THE INVENTION

As a result, media businesses face the challenge of reaching sufficiently large audiences with TV programs and advertisements. Mass-customization, which sounds like some sort of a contradiction in terms, of TV broadcasts could support the broadcasters in meeting this challenge. The inventors expect that in the era of digital TV (digital video broadcast or DVB) and digital radio (digital audio broadcast or DAB) it becomes possible to achieve media mass-customization. This requires enabling to use DVB and DAB in a way it that is currently not yet done.

The inventors propose to provide a media presentation from, e.g., a TV broadcast or a radio broadcast, to a user and to have the presentation rendered in a manner specific to per individual user. In order to provide current information about the individual user and context one or more context sensors are used. For example, RFID (radio-frequency identifier) tags in the user's clothing allow detecting body movements, the user's position relative to a reference point or presence at a certain locale. Biometric sensors are used, as in emotion recognition applications, to detect olfactory or visual cues, or other biometric information. Preferably, the output from these context-sensors is interpreted by means of a user profile that maps the sensor output, or context cue, onto data representative of the current social or activity-related identity, or mood or physiological state of the individual user. This part of the user profile is referred to as the dynamic part as it is likely to vary at a small time scale. Once the interpretation of the context cues has been determined, this interpretation is then used to control the processing of the content information. For example, the system responds by varying the program length to adjust the timing of certain events such as the time period wherein tension is being built up if the sensor signals are interpreted as that the user's attention is increasing. This is referred to as nonlinear media presentation. As another example, the system offers different (parts of) electronic content such as TV programs, e.g., different presenters or targeted commercials depending on the current social or activity-related identity of this user. As there is not an individual broadcast channel available per individual end-user, a smart way of selecting content from a limited collection is required. As yet another example, the rendered content is adjusted to match a static part of the user-profile. The static user-profile relates to the historic or diachronic habits and characteristics of the user, e.g., inferred or declared interests and preferences. For example, if the user is a sensitive person, some scenes in a thriller movie are being rendered in such a way as to reduce the shock or impact, e.g., by temporarily turning the volume of the sound down, by reducing the size or resolution or color depth of the pictures displayed on the display monitor, or by obscuring some elements from view, partly or completely. If the rendering system is part of a home network the brightness of the lights in the room where the user is watching is slightly turned up. This might especially be relevant to small children. If, on the other hand, the user is a thrill seekers or he/she at least believes to be so, cinematographic tricks are being used with opposite effects to strengthen the impact by means of turning up the sound volume, zooming in on the more spectacular scenes of the movie, etc.

Movie scenes that are accompanied by sudden loud sounds and swift actions are likely to have a higher instantaneous impact on the user than quiet scenes. These auditory and visual attributes or absence thereof can be detected in advance, e.g., in the rendering system's cache, so that by the time of their being played out, the proper cinematographic tricks can be called upon as required by the user profile, and the scene preceding the action can be adapted to build-up suspense or soften the impact. This approach can be used with regard to downloaded content, locally pre-recorded content or content supplied on an information carrier such as an optical disc. Alternatively, metadata can be supplied that is representative of the character, or contemplated impact, of the individual scenes as determined by the content provider or by a third party service. This metadata then is used as control data to control the processing according to the user-profile, dynamic, static or both. The metadata approach is particularly advantageous to streamed content or TV broadcasts, but can be used with play out of pre-recorded content as well. For example, if the metadata indicates that the next scene has a rather shocking impact on the average audience and the user profile states that the person is sensitive or nervous, the rendering of this next scene is adjusted so as to soften the blow. If the dynamic part of the user profile indicates that the user is too relaxed, or even borders on being bored an upcoming scene may get enhanced by louder sounds or is skipped, or another cinematographic trick can be employed to bring back the user's attention. The metadata is comprised in the content or is supplied separately as part of a service, for example. As a result, both static and dynamic parts of the user-profile can be exploited to personalize the rendering of the content.

Accordingly, the invention relates to a method of enabling to render mass-market content information to an individual user. The expression “mass-market content information” refers to content produced for a large number of end-users. The method comprises enabling to use a profile of the user for control of processing the content information for the purpose of personalizing the rendering during play-out of the content. The profile may comprise a dynamic part based on, e.g., current biometric information about the user that is obtained through direct or remote sensing, or the user's current activity as derived from, e.g., the user's calendar or explicit input. The profile may also comprise a static part based on at least one of: a history of the user, a declared interest, or a declared preference. In an embodiment of the invention, metadata is provided indicative of a semantic or mood-affecting aspect of the content. This metadata then is matched against the profile for the control of the processing.

An embodiment of the invention relates to a consumer electronics system for rendering mass-market content information to a user. The system comprises a memory for storing a user profile; and a controller coupled to the memory for controlling a processing of the content information for the purpose of personalizing the rendering during play-out of the content, under control of the profile. Preferably, the system has a sensor for sensing a current biometric attribute of a user; and an interpreter coupled to the sensor and the memory for interpreting an output signal from the sensor within the context of the profile. In a further embodiment, the system is configured to receive metadata indicative of a semantic or mood affecting aspect of the content. The controller is then operative to match the metadata against the profile for the control of the processing.

Another embodiment relates to control software for control of a consumer electronics apparatus for rendering mass-market content information to a user. The software is configured to use a profile of the user for control of processing the content information for the purpose of personalizing the rendering during play-out of the content.

Yet another embodiment relates to mass-market content information accompanied by metadata descriptive of a mood-affecting attribute of the content information. The metadata enables to personalize a rendering during play-out of the content information under control of a profile of the user. The content information and metadata is supplied, e.g., recorded on an information carrier such as an optical disc or in a solid-state memory, or is provided via a communication channel or broadcast channel.

### BRIEF DESCRIPTION OF THE DRAWING

The invention is explained in further detail, by way of example and with reference to the accompanying drawing wherein:

FIG. 1 is a block diagram of a system in the invention; and

FIG. 2 is a diagram illustrating operations in a process according to the invention.

Throughout the figures, same reference numerals indicate similar or corresponding features.

### DETAILED EMBODIMENTS

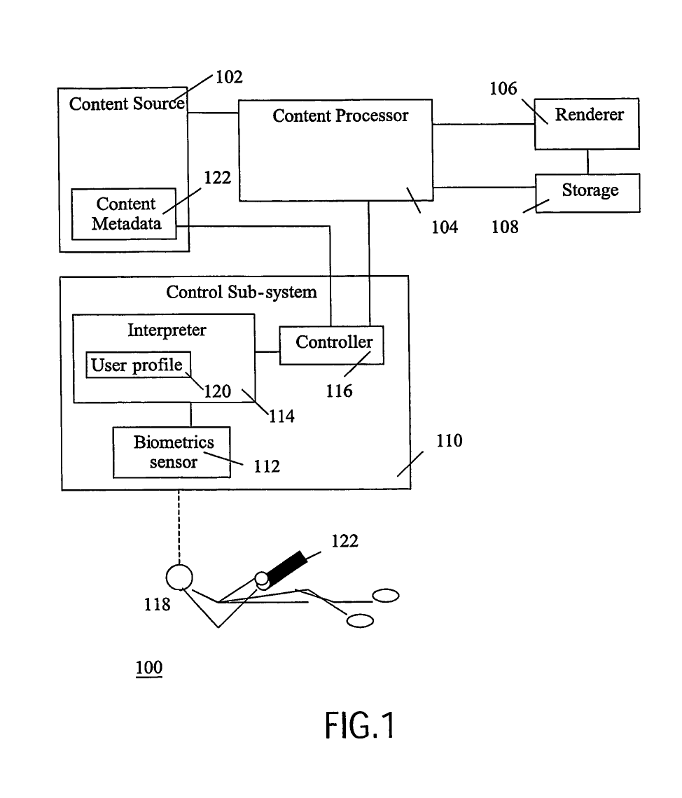

FIG. 1 is a block diagram of an information processing system 100 in the invention. System 100 comprises a source 102 of electronic content, a processor 104 for processing the electronic content from source 102, and a rendering device 106 for rendering the content as processed by processor 104. System 100 further comprises storage 108 for storing the electronic content as supplied by processor 104, e.g., for rendering later on at renderer 106. Content processor 104 is controlled via a control sub-system 110 that comprises a biometrics sensor 112, an interpreter 114 that interprets the output signal from sensor 112, and a controller 116. Biometrics sensor 112 provides an output signal representative of a current biometric attribute or biometric quality of a user 118, who is here illustrated in a laid-back position and ready to be entertained while wielding a remote 122 for control of system 100. Interpreter 114 receives the output signal from sensor 112, e.g., in the form of a varying electric current or varying voltage, or an RF or IR signal, and converts it into data forming part of the dynamic portion of an electronic user-profile 120. Profile 120 further comprises information specific to user 118 and is stored in a memory local to sub-system 110. Interpreter 114 forwards this data to controller 116 so as to enable the latter to control the processing of the content at processor 104 under control of profile 120.

Content received by processor 104 and stored in the absence of user 118, e.g., a live broadcast, may get pre-processed based on a static part of user-profile 120 and stored in storage 108, i.e., without real-time input from biometrics sensor 112. Alternatively, storage 108 records the content as received and later on serves to function as source 102 when the content is being rendered in the presence of user 118.

Source 102 comprises, e.g., a TV receiver, a radio receiver, a cable box for a video-on-demand service, or another apparatus for receipt of content supplied by a third-party service. Source 102 may also comprise a recorder, e.g., a digital video recorder (DVR) with an HDD or optical disc, a DVD player, a PC, etc., for supply of content locally available at the user's home network.

Renderer 106 comprises, e.g., a display monitor, a loudspeaker, means for stimulating the tactile or olfactory senses, etc.

Biometrics sensor 112 is operative to, e.g., sense the heartbeat of user 118, monitor the facial expression of user 118, sense certain pheromones, sense the agility or liveliness of user 118, sense brainwave patterns, sense the electrical resistance of the user's skin, etc. These attributes can be used to determine or infer the current mood or state of user 118, more or less accurately. For example, if interpreter 114 receives the signal from sensor 112 with a sudden change in the quantify measured by sensor 112, e.g., a substantial increase in heart beat frequency within a few seconds, the signal may be interpreted as that user 118 is getting excited or wound up. Interpreter 114 then instructs controller 116 to control the processing of processor 104 depending on user profile 120 as regards excitement preferences. Interpreter 114 may use the static part of user profile 120 to associate a particular mood of user 118 with the signals sensed by sensor 112. To this end, interpreter 114 may use general data available from, e.g., demographic studies relating to physiological aspects. For example, the frequency spectrum of heartbeats of a human being and brain wave patterns can, in general, be sub-divided into ranges that are associated with relaxed and tense moods. Alternatively, or in addition, interpreter 114 is adaptive in the sense that it learns from past behavior of user 118, e.g., by means of explicit input from user 118 regarding his/her mood, preferences or interests, or implicitly by inference or trial-and-error. Knowledge thus available and gathered forms user-profile 120.

In an embodiment of the invention, the content supplied by source 102 is accompanied by metadata that indicates the type and intensity of the expected emotional impact of a particular scene on the average viewer. For example, the metadata indicates that a particular scene is rated as “scary”. During the rendering of this scene interpreter 114 receives signals from sensor 112 that are expected to reflect this emotional impact somewhat, possibly modified by this user's individual profile 120. Now, if the signals indicate that the impact sensed does not match the impact expected, content attributes such as sound volume and/or spectrum, color intensities or play-out speed, etc., can be adjusted to change this discrepancy between expectation and measurement, preferably again under control of profile 120.

In another embodiment, sensor 112 operates in a remote fashion, i.e., without physically contacting the user. Examples have been given above. An advantage of such sensor is that the user does not have to wear any additional equipment.

In a further embodiment, interpreter 114 and controller 116 are implemented in software that is installed on the user's home network or on a programmable piece of CE equipment. For example, a service provider or content provider may market this software for providing an enhanced experience of electronic content, and may make it available for downloading.

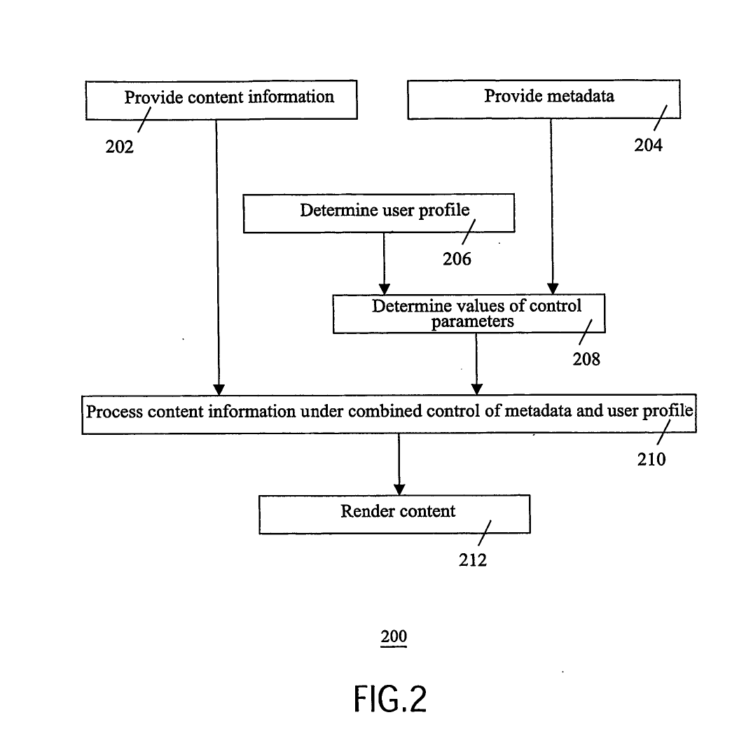

FIG. 2 is a diagram illustrating the operations in a process 200 carried out in system 100. In a step 202, content information is supplied. In a step 204 the metadata is supplied. As mentioned above, the metadata is indicative of a mood-affecting attribute of the content information, e.g., in a segmented fashion per scene or continuously varying with the evolution of the content. Steps 202 and 204 may be combined, e.g., the content and metadata are supplied recorded on a DVD. Alternatively, steps 202 and 204 are separate. For example, the content is supplied via a live broadcast channel and the metadata has been downloaded beforehand from an Internet site or is supplied in the vertical blanking interval during the video broadcast, etc. In a step 206, the user profile is determined. The metadata and user profile are used to determine the relevant values of the control parameters in a step 208. The control parameters enable control of the eventual rendering of the content, e.g., to enhance the experience of being involved or immersed in the content.

Incorporated Herein by Reference:

U.S. Ser. No. 09/802,618 (attorney docket US 018028) filed Mar. 8, 2001 for Eugene Shteyn for ACTIVITY SCHEDULE CONTROLS PERSONALIZED ELECTRONIC CONTENT GUIDE and published as U.S. patent application publication no. 20020133821. This document relates to determining electronic content information and the time slots for play-out based on the activities scheduled in the user's electronic calendar and the user's profile or declared interests. In this manner, the recording and downloading of content is automated based on the user's life style.

U.S. Ser. No. 09/635,549 (attorney docket US 000209) filed Aug. 10, 2000 for Eugene Shteyn for TOPICAL SERVICE PROVIDES CONTEXT INFORMATION FOR A HOME NETWORK and published under PCT as International Application WO 0213463. This document relates to a consumer apparatus that is made an intuitive component of a user-interface to a topical server. A specific user-interaction with the apparatus or its proxy on the home network causes a request to be sent to a specific server on the Internet based on a predefined URL. The home network receives a particular web page from the server with content information dedicated to the context of use of the apparatus.

U.S. Ser. No. 09/568,932 (attorney docket US 000106) filed May 11, 2000 for Eugene Shteyn and Rudy Roth for ELECTRONIC CONTENT GUIDE RENDERS CONTENT RESOURCES TRANSPARENT, and published under PCT as International Application WO 0186948. This document relates to a data management system on a home network that collects data that is descriptive of content information available at various resources on the network. The data is combined in a single menu to enable the user to select from the content, regardless of the resource.

U.S. Pat. No. 6,356,288 (attorney docket PHA 23,319) issued to Martin Freeman and Eugene Shteyn for DIVERSION AGENT USES CINEMATOGRAPHIC TECHNIQUES TO MASK LATENCY. This patent relates to a software agent that is a functional part of a user-interactive software application running on a data processing system. The agent creates a user-perceptible effect in order to mask latency present in delivery of data to the user. The agent creates the effect employing cinematographic techniques. Within the context of the invention as discussed above, such software agent can be modified to obscure parts of the content being rendered or otherwise divert the user's attention under combined control of the biometric sensor and the user profile, instead of under control of the network latency.

U.S. Ser. No. 09/519,546 (attorney docket US 000014) filed Mar. 6, 2000 for Erik Ekkel et al., for PERSONALIZING CE EQUIPMENT CONFIGURATION AT SERVER VIA WEB-ENABLED DEVICE, and published as International Application WO 0154406. This document relates to facilitating the configuring of consumer electronics (CE) equipment by the consumer by means of delegating the configuring to an application server on the Internet. The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

U.S. Ser. No. 09/585,825 (attorney docket US 000123) filed Jun. 1, 2000 for Eugene Shteyn for CONTENT WITH BOOKMARKS OBTAINED FROM AN AUDIENCE'S APPRECIATION, published as International Application WO 0193091. This document relates to providing bookmarks for indicating elements or portions of information content that are likely to be of great interest to an audience. A broadcast station can offer these bookmarks for sale or lease to a third party for inserting data into the information content at the bookmarked locations. The third party can insert, preferably semantically related, advertisements in the information content close to the indicated portions that the audience is likely to appreciate.

U.S. Ser. No. 09/823,658 (attorney docket US 018032) filed Mar. 29, 2001 for Jan van Ee for VIRTUAL PERSONALIZED TV CHANNEL, and published as International Application WO 02080552. This document relates to a data management system that creates a personalized content information channel for an end-user by enabling to automatically play out a plurality of concatenated content information segments. These segments or programs have been selected on the basis of a criterion independent of a respective resource of respective ones of the segments.

1. A method of enabling to render mass-market content information to a user, the method comprising enabling to use a profile of the user for control of processing the content information for the purpose of personalizing the rendering during play-out of the content information.

2. The method of claim 1 wherein the profile comprises a dynamic part with biometric information about the user.

3. The method of claim 2, comprising acquiring the biometric information via a sensor coupled to the user.

4. The method of claim 1, wherein the profile comprises information about a current activity of the user.

5. The method of claim 1, wherein the profile comprises a static part based on at least one of: a history of the user, a declared interest, a declared preference.

6. The method of claim 1, comprising:
providing metadata indicative of a mood affecting aspect of the content; and
enabling to match the metadata against the profile for the control of the processing.

7. The method of claim 1, wherein the processing comprises storing the content for personalized rendering later on.

8. A consumer electronics system for rendering mass-market content information to a user, the system comprising:
a memory for storing a user profile; and
a controller coupled to the memory for controlling a processing of the content for the purpose of personalizing the rendering during play-out of the content, under control of the profile.

9. The system of claim 8, further comprising:
a sensor for sensing a current biometric attribute of a user;
an interpreter coupled to the sensor and the memory for interpreting an output signal from the sensor within the context of the profile.

10. The system of claim 8, configured to receive metadata indicative of a semantic or mood affecting aspect of the content, and wherein the controller is operative to match the metadata against the profile for the control of the processing.

11. Control software for being used to control a consumer electronics apparatus for rendering mass-market content information to a user, the software being configured to use a profile of the user for control of processing the content information for the purpose of personalizing the rendering during play-out of the content.

12. (canceled)
